(19) United States
(12) Patent Application Publication
(10) Pub. No.: US 2004/0204121 A1
(43) Pub. Date: Oct. 14, 2004

(54) Method and apparatus for communicating and managing information

(76) Inventor: Tareq Risheq, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/412,791

(22) Filed: Apr. 10, 2003

(51) Int. Cl. H04M 1/00; H04B 1/38

(52) U.S. Cl. 455/564

(57) ABSTRACT

An organizer and method of managing information operated by multiple users, such as family members at any location is provided. In one embodiment, the organizer includes a printer. The organizer can include features such as synchronization, a voice memo system, a timer, a recipe exporting system, a schedule, a to-do list and other features. The organizer is adapted to be mounted on either horizontal or vertical surfaces. Further, the organizer is configured to automatically update a master user data center with data from multiple individual user, and allow a master user to access and view such data of multiple individual user.

### BACKGROUND OF THE INVENTION

1. Field of the Invention

The present invention relates to digital organizers and, in particular, to a method and apparatus for communicating and managing information by multiple users of the same organizer.

2. Description of the Related Art

Personal digital assistants, or PDA'S, are hand-held computers that can be used to store various personal information of a single user. The information can be inputted into the PDA by downloading the information from other computer systems or directly inputting the information into the PDA. PDA's typically include personal information, such as contact information, calendar information, etc.

Personal computers also provide similar informational capabilities as a PDA, while also allowing multiple users to access the computer. Typically, an entire family can access the computer; however, personal computers tend to be used for a variety of other purposes, such as work and school related activities; internet-related activities, such as sending and receiving e-mail and online research and shopping; and entertainment, such as video games, movies, and music. Personal computers are typically located in a home office and are not portable.

PDA's and personal computers are limited in many ways. They do not provide an easily accessible system that can be placed anywhere in a home. They also do not provide a variety of organizational functions that allow multiple users to synchronize their information into a single system.

Accordingly, there is a need for a multi-user organizer that can be easily accessed and used by all family members at any location.

### SUMMARY OF THE INVENTION

The invention provides a method and an organizer for communicating, managing and storing information. In one embodiment, the organizer comprises a housing having first and second portions connected at an angle between the first and second portions, the angle being selected to allow placement of the body on a substantially horizontal or substantially vertical surface. The organizer further comprises an input portion located substantially on an upper surface of the first portion and configured to allow a user to enter instructions or information into the organizer, wherein a bottom surface of the first portion is configured to be placed substantially in contact with the horizontal surface. The organizer further comprises a display portion located substantially on an upper surface of the second portion and configured to display information to the user, wherein a bottom surface of the second portion is configured to be placed substantially in contact with the vertical surface.

In another embodiment, the invention provides a method of managing and storing information in an organizer. The method comprises inputting data into the organizer by a plurality of individual users, the data representing information about at least one activity associated with a respective individual user. The method further comprises copying the data inputted by the plurality of individual user into a master data file in the organizer, the master data file being accessible by a master user via the organizer. The method further comprises verifying at least the authority of the master user to access the master data file containing the copied data. In yet another embodiment, the invention provides an organizer comprising means for inputting data into the organizer by a plurality of individual users, the data representing information about at least one activity associated with a respective individual user. The organizer further comprises means for copying the data inputted by the plurality of individual users into a master data file in the organizer, the master data file being accessible by a master user via the organizer. The organizer further comprises means for verifying at least the authority of the master user to access the master data file containing the data inputted by the plurality of individual users. The apparatus and method have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Invention” one will understand how the features of the system and methods provide several advantages over traditional systems and methods.

### BRIEF DESCRIPTION OF THE DRAWINGS

FIG. 1 is a perspective view of an organizer in accordance with an embodiment of the present invention.

FIG. 2 is a front view of the organizer of FIG. 1.

FIG. 3 is a side view of the organizer of FIG. 1.

FIG. 4 is a back view of the organizer of FIG. 1.

FIG. 5 is a bottom view of the organizer of FIG. 1.

FIG. 6 is a front view of the organizer of FIG. 1 with a printer.

FIG. 7 is a back perspective view of the organizer and printer of FIG. 6.

FIG. 8 is a perspective view of the companion card sliding into the organizer of FIG. 6.

FIG. 9 is a perspective view of a companion card.

FIG. 10 is a perspective view of the organizer of FIG. 1 with a printer mounted on a vertical surface.

FIG. 11 is a functional block diagram of the organizer.

FIG. 12 is a flow chart showing the multi-user capabilities of the organizer.

FIGS. 13A-C are schematic views illustrating the multi-user capabilities of the organizer.

FIG. 14 is a flow chart showing a voice memo process of the organizer.

FIG. 15 is a flow chart showing the timer process of the organizer.

FIG. 16 is a flow chart showing the companion card synchronization process of the organizer.

FIG. 17 is a flow chart showing the recipe exporting process of the organizer.

### DETAILED DESCRIPTION OF THE INVENTION

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

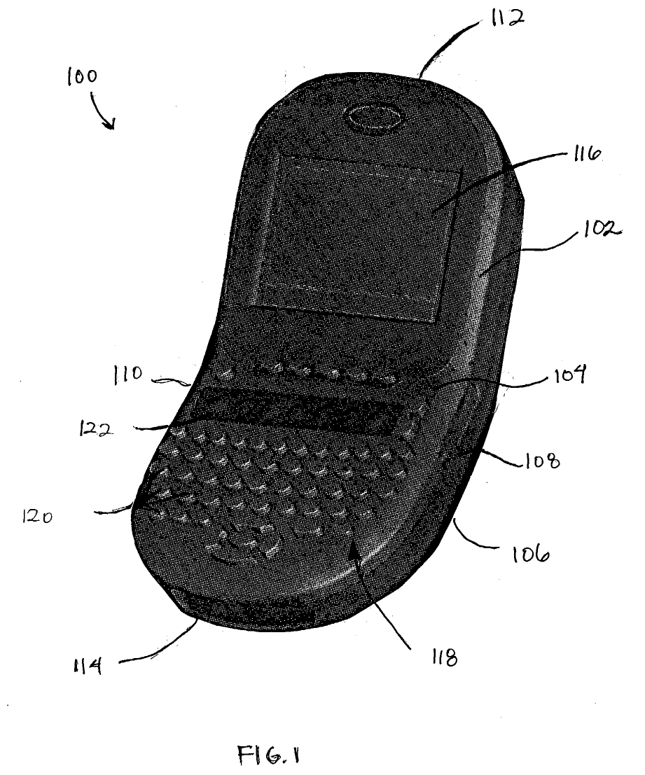

In one embodiment, the invention is directed to a multi-user organizer 100, as shown in FIG. 1. The organizer 100 includes a housing 102 having a front face 104 and a back face 106, a first side 108 and a second side 110, and a top end 112 and a bottom end 114. The housing 102 may be made of any material, such as a hard plastic or metallic material. The housing 100 may be injection molded.

A display screen 116 is provided on the front face 104. The display screen 116 may be an LCD display or a plasma display, or any other display that permits easy and accurate viewing of information. In one embodiment, display screen 116 is a touch screen, such that data may be manipulated from the display screen 116.

The front face 104 also includes a touch pad 118 including a plurality of keys 120 and indicia 122 for entering and accessing information. In one embodiment, indicia 122 may include numbers, letters, and symbols. Also, additional or fewer keys may be used depending on the particular needs of users of the organizer 100. The touch pad keys may be pressed by a user's fingers, or alternatively, with a stylus (not shown).

In one embodiment, the organizer 100 is about 52 inches wide, about 92 inches in length, and about ¾ inches thick. The size of the unit is dependent only upon the desired size of the display 116 and touch pad 118 and could be as small as 2 inches by 4 inches or smaller and as large as 2 feet by 3 feet or larger.

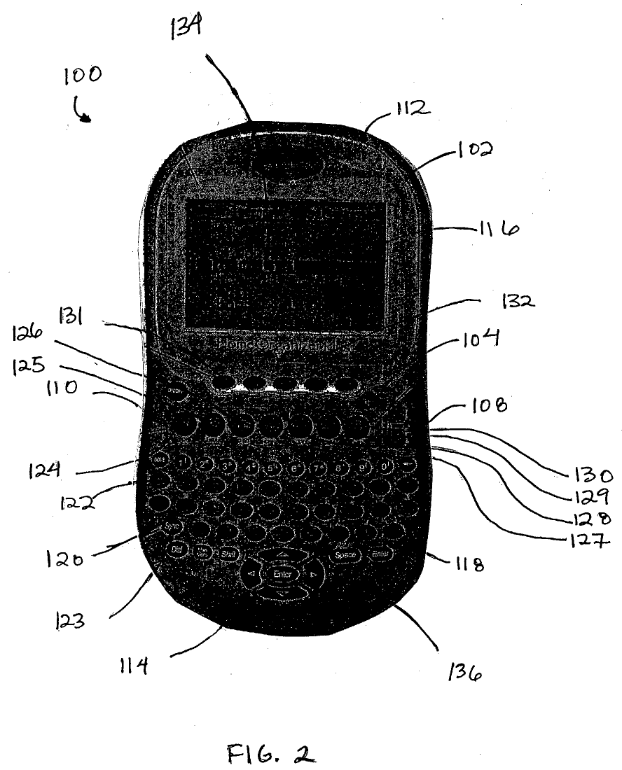

As noted above, FIG. 2 is a front view of the organizer 100. In particular, FIG. 2 shows the display 116 and keypad 118 in detail. Keypad 118 may include keys designated to directly access features and processes of the organizer. For example, in one embodiment, key pad 118 may include a phone key 124 for accessing a phone list, a schedule key 125 for accessing a schedule, a to do list key 126 for accessing a to do list, a shopping key 127 for accessing a shopping list, a recipe key 128 for accessing a recipe list, a voice key 129 for accessing a voice memo system, and a timer key 130 for accessing a kitchen timer. The key pad 118 may also include keys for accessing user profiles. For example, in one embodiment, key 131 is designated as a master user and keys 132 are designated for each individual user. In another embodiment, keys 131 and 132 are each designated for individual users.

The keys 120 control a menu 134 that a user may view at the display screen 116. The menu 134 may also be accessed using keys 136, which permit a user to scroll up and down in the menu, and select particular features. As discussed above, a user may alternatively select a key, such as the to do list key 126 to go directly to the to do list feature. The keys 120 and indicia 122 are exemplary, and may be arranged in any way which may be easily accessed by a user.

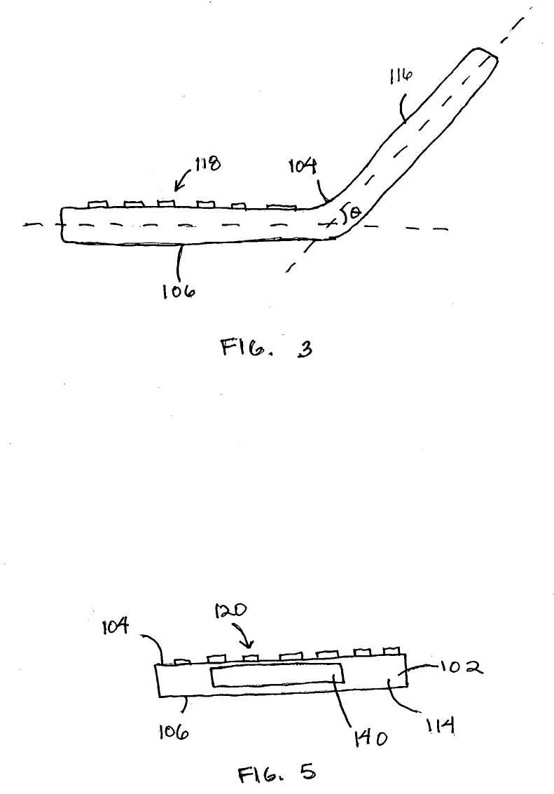

As noted above, FIG. 3 is a side view of the organizer of FIG. 1. As shown in FIG. 3, it is desirable to have the housing 102 of the organizer angled, such that the display screen 116 is at an angle θ of about 15 degrees to 30 degrees from the horizontal plane with respect to the touch pad 118. In some embodiments, the angle θ is about 25 degrees. The angled orientation of the display screen 116 and touch pad 118 permits the organizer 100 to be easily used on both horizontal and vertical surfaces, as will be described hereinafter. The actual angle between the display screen 116 and touch pad 118 provides optimum viewing to a user when the organizer is positioned on either a horizontal or vertical surface. In one embodiment, the angle θ between the display screen 116 and touch pad 118 is adjustable.

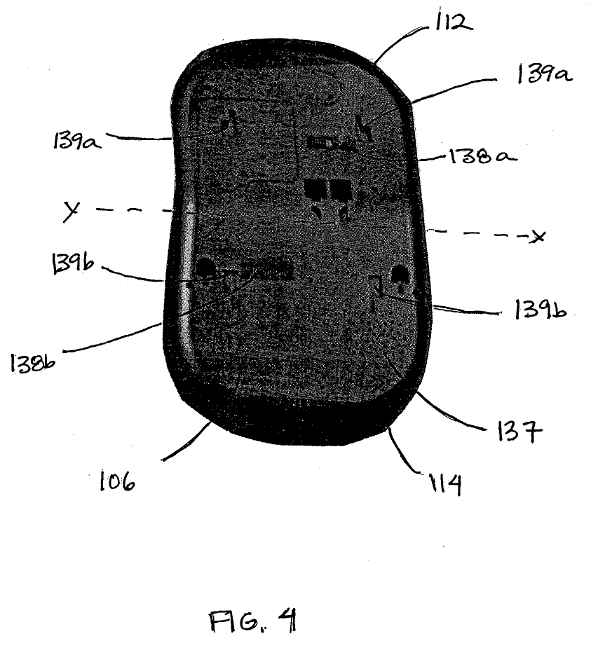

As described above, FIG. 4 is a back view of the organizer 100. In one embodiment, the back face 106 includes a speaker 137, which is provided to provide audible information, such as voice memos, or instruction to the user. The back face 106 of the organizer 100 includes one or more electrical interfaces 138a and 138b and one or more mechanical connectors 139a and 139b. In one embodiment, the electrical interfaces 138a and 138b are adapted to connect to a printer, as will be discussed hereinafter. The electrical interfaces 138a and 138b and mechanical connectors 139a and 139b are located on the organizer near the top end 112 and near the bottom end 114. The particular location(s) of these connectors and interfaces may not be critical to the invention. However, it is desirable to locate or place the mechanical connectors 139a and 139b at respective locations to accommodate for attaching external devices (e.g., printer) to the organize 100 and/or allow fixating the organizer 100 to a surface. An axis x-x is shown between the top end 112 and bottom end 114 dividing the back face 106 of the organizer 100. The mechanical connectors 139a and 139b are reversed with respect to the axis x-x to accommodate for reversibility of the organizer between vertical and horizontal surfaces. The electrical interfaces 138a and 138b are also reversed with respect to the axis x-x to accommodate for an external device (e.g., a printer) to connect to either of the electrical interfaces 138a and 138b in an upright or upside-down position. Accordingly, the printer may be attached to either the top end portion or bottom end portion of the organizer 100. The organizer 100 may also include electrical interfaces (not shown in this figure) adapted for connection to a phone, a personal computer, a personal digital assistant, or other similar devices. The electrical interfaces permit data transfer between the organizer and printer. In one embodiment, the electrical interfaces 138 also permit power transfer between the organizer and printer.

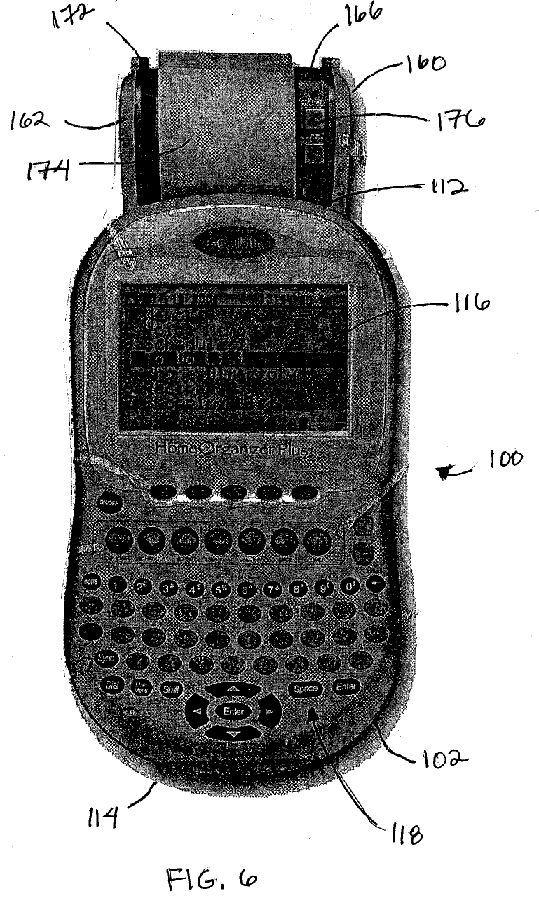

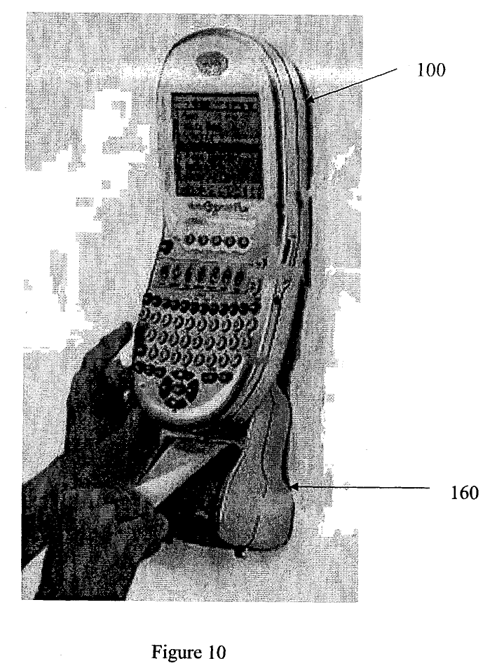

As noted above, FIG. 5 is a bottom view of the organizer of FIG. 1. As shown in FIG. 5, the bottom end 114 of the organizer 100 may be provided with a receiving slot 140, for receiving a companion card 150 (See FIGS. 9 and 10), as will be described hereinafter. The receiving slot 140 has dimensions selected to accommodated insertion of the companion card 150. In one embodiment, the receiving slot 140 includes a male, two-pin serial electrical interface (not shown) which engages with a corresponding female, two pin serial electrical interface on the companion card 150. In one embodiment, the connection between the receiving slot 140 and the companion card 150 may be through a universal serial bus (USB)-type data interface or infrared data transfer.

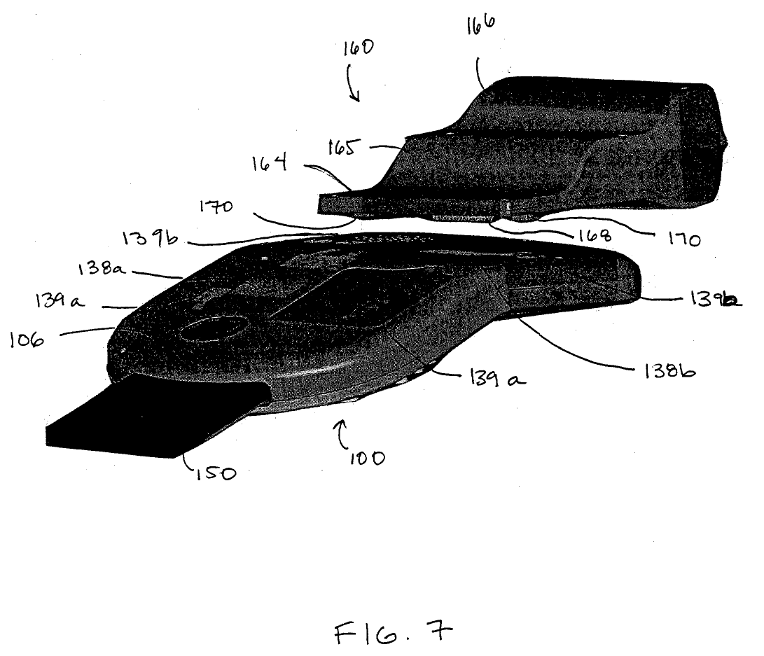

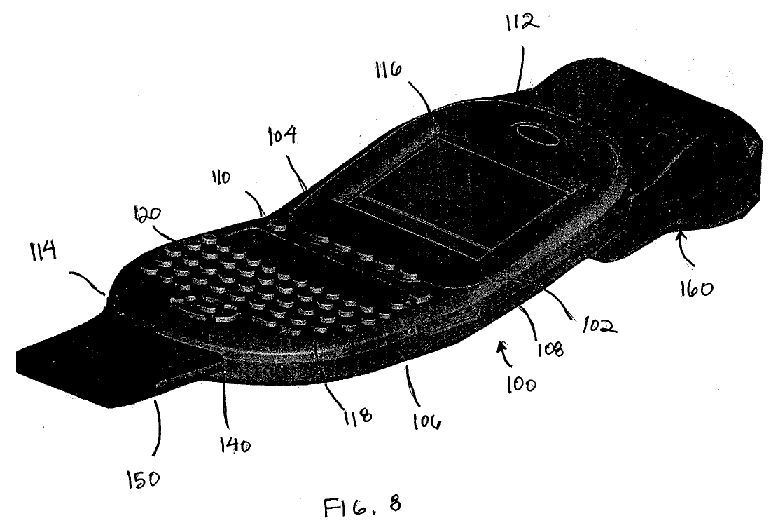

FIG. 6 is a front view of the organizer of FIG. 1 with a printer. As shown in FIG. 6, the organizer 100 includes or operates with an attached printer 160. In one embodiment, the printer 160 includes a housing 162. The housing 162 includes an engagement portion 164 (see FIG. 7) adapted for attaching the printer 160 to the organizer 100, a transition section 165 (see FIG. 7) and a printer portion 166 adapted for housing the printer elements. The engagement portion 164 may be flat and is adapted to engage with the back face 106 of the organizer at either the top end 112 or bottom end 114. The printer portion 166 is adapted to extend above the top end 112 or below the bottom end 114 of the organizer 100 when the engagement portion 164 is engaged with the organizer 100. In one embodiment, the printer portion 166 may be thicker than the transition section 165, which is thicker than the engagement portion 164.

In one embodiment, the printer 160 includes a paper roll 172 on the printer portion 166. In one embodiment, the printer 160 may be a line thermal dot printer. The printer 160 may also be a dot matrix printer, an inkjet/bubble jet printer, laser printer, or any other printer that may compactly adapt to integrate with the organizer 100. In one embodiment, the paper roll 174 is adapted for paper that is about 2 inches wide. In one embodiment, the printer 160 is adapted for printing labels.

In one embodiment, the printer 160 is provided with a button 176 for touch-button printing. In other embodiments, the organizer 100 may be provided with a print key (not shown), which may be selected from the keys 120 or from icons in the display 116 for printing. When a user activates (e.g., presses or hits) such a print key or icon causes the organizer 100 to instruct the printer 160 to print a desired record. In still other embodiments, a user may run a program instructing the printer 160 to print through a menu selection.

In one embodiment, the printer 160 includes a serial port for electrically interfacing with the organizer 100. In one embodiment, the printer 160 uses hardware handshaking. In one embodiment, the printer 160 may be a PDA printer provided by Infinite Peripherals, which may be found at www.ipcprint.com. However, printers having other electrical interfaces, such as USB, parallel interface, or others, may be used.

As noted above, FIG. 7 is a back perspective view of the printer 160 and organizer 100. FIG. 7 illustrates the mechanical and electrical engagement between the printer 160 and organizer 100. The printer 160 is adapted to electrically interface with the organizer 100. The engagement portion 164 of the housing 162 includes an electrical interface 168 which interfaces with the corresponding electrical interfaces 138a and 138b on organizer 100. In one embodiment, the printer 160 may have an independent power supply. In other embodiments, the printer 160 may receive power from the organizer 100. In still other embodiments, the printer 160 may include a power supply that also powers organizer 100. In one embodiment, the printer 160 is powered by a battery pack, an AC/DC adapter, or a combination thereof.

In one embodiment, the engagement portion 164 of the printer 160 includes one or more mechanical connectors 170 for engaging with the one or more mechanical connectors 139a or 139b in organizer 100. In one embodiment, the one or more mechanical connectors 170 comprise a hook or tab for engaging with the corresponding one or more mechanical connectors 139a or 139b in the organizer 100. In other embodiments, the organizer 100 includes one or more mechanical connectors 139a and 139b that comprise a hook or tab and the one or more mechanical connectors 170 include an opening adapted to receive the one or more mechanical connectors 139a or 139b of the organizer 100.

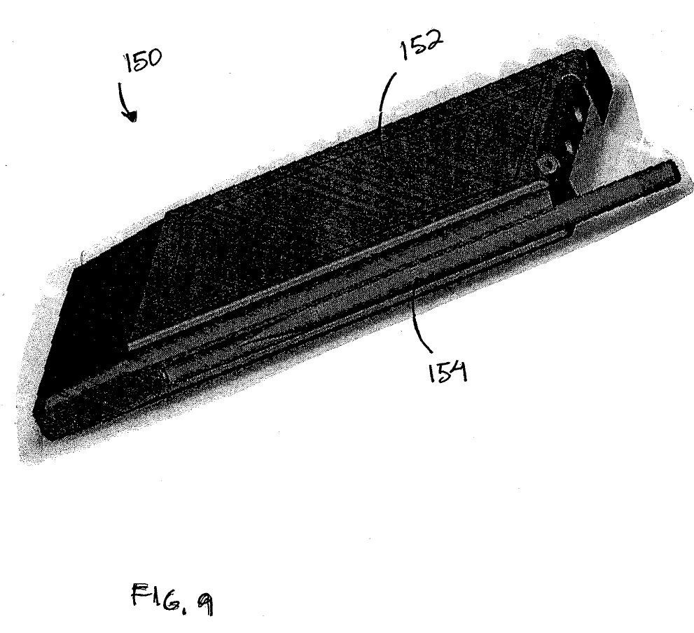

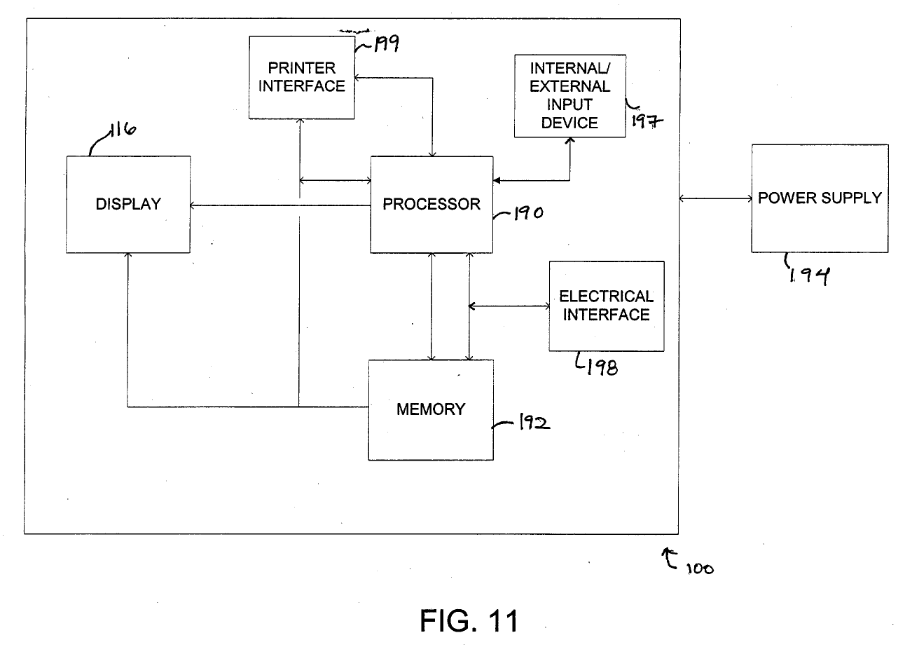

As noted above, FIG. 8 is a perspective view of the companion card sliding into the organizer of FIG. 6. As shown in FIG. 8, the companion card 150 slides into the receiving slot 140 of the organizer 100, thereby permitting data transfer between the organizer 100 and companion card 150. The data transfer between the companion card 150 and organizer 100 is referred to as synchronization, as further described in connection with FIG. 11.

As noted above, FIG. 9 is a perspective view of a companion card 150 in accordance with one embodiment of the invention. Generally, a user may wish to take away information contained in the organizer without having to write down or print such information (e.g., telephone records, shopping list, schedules, voice memos). The companion card 150 is provided to store such information for the user to take away to another location (e.g., office, grocery store, or other place remote from the location of the organizer 100). Additionally, while at a location remote from the location of the organizer 100, the user may wish to supplement (i.e., add new information), delete, or modify information in the companion card 150. In that case, the companion card 150 supports such functions by providing a touch screen 152 and stylus 154 for entering and managing information. In one embodiment, the companion card 150 may include a cover (not shown) over the touch screen 152. In other embodiments, the companion card 150 includes a display screen and a keypad. Users may store and view information entered into the companion card 150. The companion card 150 allows an individual user to access information anywhere. Upon return to the location of the organizer 100, the user may insert or connect the companion card to the organizer 100 to synchronize the two devices, thereby updating the organizer 100 with information that may have been added or modified in the companion card 150 while the user was away. Conversely, synchronization may include updating the companion card 150 with information that was added or modified in the organizer 100 while the user was away.

In one embodiment, each individual user has their own companion card 150, which may be inserted into the receiving slot 140 for transferring data. In one embodiment, the companion card 150 is about the size of a credit card. In one embodiment, the companion card 150 permits a user to have access to their information at any location, such that data may be inputted or transferred to the companion card 150, and later transferred to the organizer 100.

In one embodiment, the receiving slot 140 includes a card reader, which may include a pin code identifying a user. In one embodiment, the card reader is adapted for data input only. Alternatively, the card reader may be adapted for data transfer to and from the organizer 100. In one embodiment, the companion card 150 transmits data wirelessly, such as via RF links, or other known methods for transmitting data wirelessly.

As noted above, FIG. 10 is a perspective view of the organizer of FIG. 1 with a printer mounted on a vertical surface. The organizer 100 may be mounted on a vertical surface or placed on a horizontal surface, such that the organizer 100 is reversible. As shown in FIG. 10, the organizer 100 is shown mounted on a vertical surface 180. As described above, the printer 160 may be attached at the top end 112 or bottom end 114 of the organizer 100. When the printer 160 is attached to the top end 112 of the organizer, the organizer 100 is adapted for use on a horizontal surface. See FIG. 6. When the printer 160 is attached to the bottom end 114 of the organizer, the organizer 100 is adapted for use on a vertical surface. See FIG. 10.

The printer 160 permits the organizer to be removably mounted on either surface. The one or more mechanical connectors 170 on the printer 160 are adapted to engage with the one or more mechanical connectors 139a near the top end 112 or mechanical connectors 139b near the bottom end 114 of the organizer 100. The electrical interface 168 on the printer is also adapted to engage with the electrical interface 138a near the top end 112 or the electrical interface 138b near the bottom end 114 of the organizer 100. The variation in thickness between the engagement portion 164, transition section 165, and printer portion 166 compensates for the angle θ between the display screen 116 and the touch pad 118.

In one embodiment, a mounting bracket (not shown) is provided, which permits organizer 100 to be mounted on vertical surfaces, as shown in FIG. 10. In other embodiments, an adhesive (not shown) may be used for mounting the organizer 100 on a vertical surface. The reversible aspect of the organizer 100 permits a user to choose an optimal location for accessibility to the organizer. The organizer 100 is removably mounted on either a horizontal surface or a vertical surface, such that a user may choose the optimum location, and change the location according to their desires. Reversibility provides flexibility to the users, such that the organizer 100 may be placed at an optimal location for any user.

FIG. 11 is a functional block diagram of the organizer 100 comprising one or more processor 190 and one or more memory 192. The organizer 100 may comprise one or more (or connect to an external) power supply 194. The processor 190 may include programmed instructions and/or (e.g., firmware) to coordinate and operate the various functions discussed above. The memory 192 may contain software for running the operations and storing user data provided with the organizer, as will be described hereinafter. The power supply 194 may include a battery and/or AC/DC power converter. The processor 190 and memory 192 permit a user to store, manipulate, and transmit data within the various functional units of the organizer 100. In one embodiment, the memory 192 is capable of importing and exporting data to and from the processor. The imported data may be inputted directly into the organizer or transferred to the organizer via an external device, as previously described. Exporting of data may include displaying the data stored in memory to the user via the display 116. In one embodiment, the organizer 100 includes about 32 kilobytes (kB), 64 kB, 128 kB, 256 kB, 2 Megabytes (MB), or several megabytes of memory storage capabilities. The actual memory storage capabilities may vary. The processor 190 and memory 192 enable a user to view and manipulate data at the display 116.

The organizer 100 also includes an internal/external input device 197. The internal/external input device 197 allows for communication between the organizer 100 and external devices, such as a PC, telephone, and the like.

The companion card 150 permits synchronization of information between itself and the organizer 100. The organizer 100 includes an electrical interface 198, which permits data transfer between the companion card 150 and the processor 190 and/or memory 192 of the organizer 100. In one embodiment, each user may input his or her own data into the companion card 150. In one embodiment, the organizer 100 automatically synchronizes data from the companion card 150 with the data for that user stored in memory 192. In other embodiments, the organizer 100 requires a password to synchronize data or permits users to selectively synchronize data from the companion card. In one embodiment, the companion card 150 permits bi-directional data transfer, such that information may also be transferred from the organizer 100 to the companion card 150.

The organizer 100 also includes a printer interface 199 which permits data transfer between the printer 160 and the processor 190, memory 192 and/or display 116 of the organizer 100. As described above, a user may print directly from the printer 160 or indirectly through the organizer 100.

In one embodiment, the organizer 100 may include features and processes, such as, but not limited to, a note feature, a voice memo feature, a schedule, a to-do list, a phone directory, a phone dialer, a recipe system, a shopping list, an alarm, a calculator, a calendar, a kitchen timer, synchronization, and multi-user accessibility.

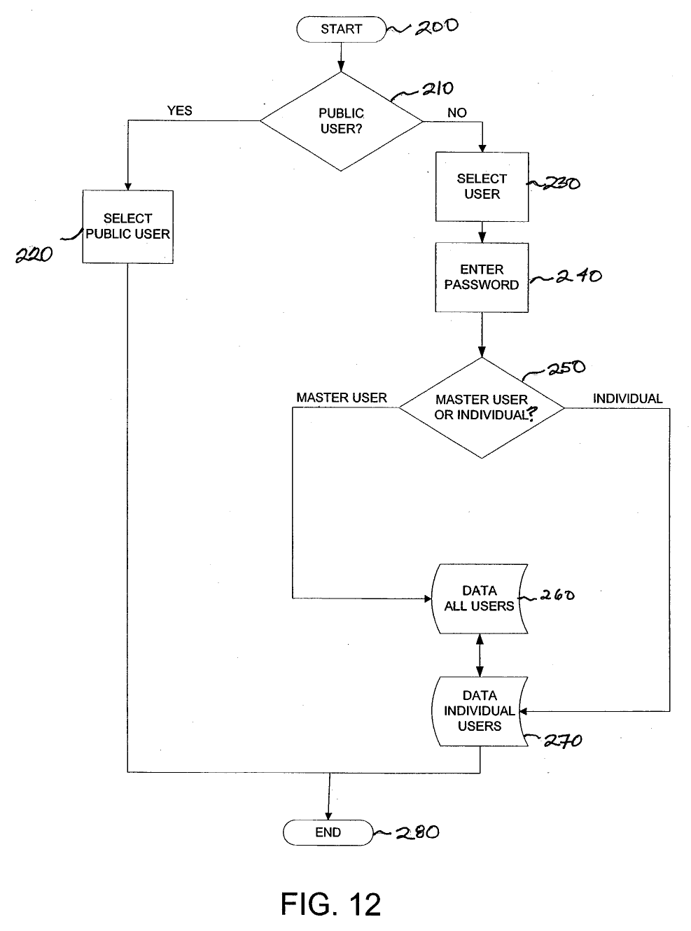

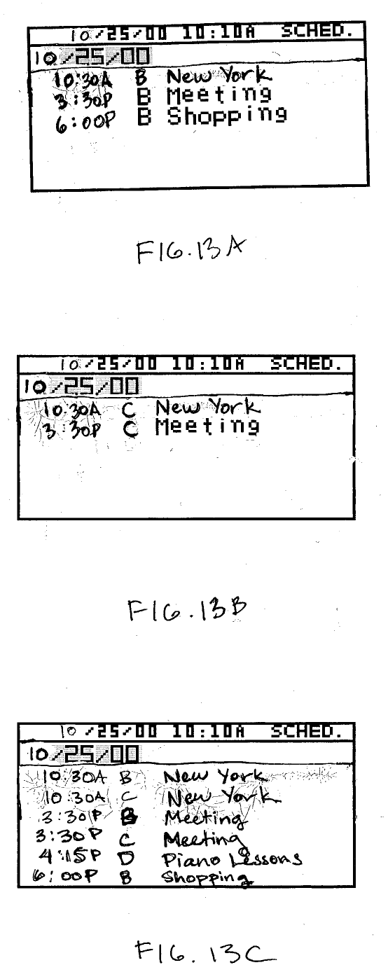

FIG. 12 is a flow chart of the multi-user capabilities of the organizer. In one embodiment, the organizer 100 supports multi-user accessibility, whereby two or more users may operate the organizer 100 and access private or public files, depending on the user's authority. In one embodiment, the user may start the process at block 200. At block 210, the user may either access the organizer 100 as a public user (guest) or private user. If the user is a public user, the process proceeds to block 210 wherein the organizer 100 is configured to display to the public user any public records that are so designated by the organizer administrator by pressing a button or icon identifying the user as a guest user. If the user is not a public user, the process proceeds to block 230 wherein a user may continue the process by entering either a user ID (or pressing a button or icon identifying the users as a private user), or select a user name from a list. The organizer 100 determines and verifies the identity of the user. If the user is a private user, the process then proceeds to block 240 wherein the user may enter a password to get authorized access of only his/her records. The process proceeds to block 250, wherein the user accesses the organizer 100 as a master user or individual user. The organizer 100 is configured to determine whether or not the user is master or individual user based on, for example, the user name and/or password. If the user is a master user, the process then proceeds to block 260, wherein the organizer 100 is configured to display to the master user any records that are so designated by the organizer to be shown to the master user. If the user is an individual user, the process then proceeds to block 270, wherein the organizer 100 is configured to display to the individual user any records that are so designated by the organizer to be shown to the individual user.

The multiple user processes may be accessed from the touch pad 118 by contacting a key 131 or 132 designated for a particular user. For example, each user may be designated by indicia such as a letter, such as, for example, “A”, “B”, “C”, “D” and “E”. In one embodiment, “A” may represent a master user, while “B”, “C”, “D” and “E” may represent individual users. In one embodiment, the password is necessary to prevent other users from accessing private user data.

The process depicted in this flowchart and all flowcharts in this application may be implemented using software/firmware programming languages/techniques which are well-known in the organizer, personal data assistant, computer, and software industry. This process terminates at block 290.

FIGS. 13A-C are schematic views illustrating the multi-user capabilities of the organizer. The data between the individual users may be shared and provided in a master data center that can be accessed by the master user. More particularly, data entered by the individual user may be automatically reported to or updated in the master data center, which is accessible by the master user. In one embodiment, it is desirable to have the master data center be accessible by only the master user. For example, an individual user may enter a scheduled activity into a scheduling feature of the organizer 100. The scheduled activity is automatically updated into the schedule in the master data center, such that the master user can view the scheduled activity provided by the individual user, as well as the scheduled activities of other individual users. In effect, the master user may access and view the schedules or events programmed for all other users. Although the data sharing has been described with reference to a scheduling feature, the data sharing is not limited to such scheduling feature but may also be available with other features provided with the organizer 100.

Thus, data between the individual users may be shared and provided in a master data center that can be accessed by the master user. For exemplary illustration, FIG. 13A shows a monthly calendar that can be used to access a particular date. FIG. 13A shows a calendar for October 2002. In some embodiments, as shown in FIG. 13A shows the day view of October 25 for an individual user, B. In this example, the schedule for individual user B shows being in New York at 10:30 AM, being at a meeting at 3:30 PM, and going shopping at 6:00 PM. FIG. 13C shows the day view of the same day shown in FIG. 13B for another individual user, C. In this example, the schedule for individual user C shows being in New York at 10:30 AM, and being at a meeting at 3:30 PM. FIG. 13C shows the master user's view of the scheduled events for all private users on October 25, including users B and C, as well as a user D (whose schedule was not previously discussed above, but shows a piano lesson at 4:15 PM). As shown in FIG. 13C, the master user is able to access and view the scheduled events of each individual user collectively to see the entire activity for all users on a particular day or at a particular time.

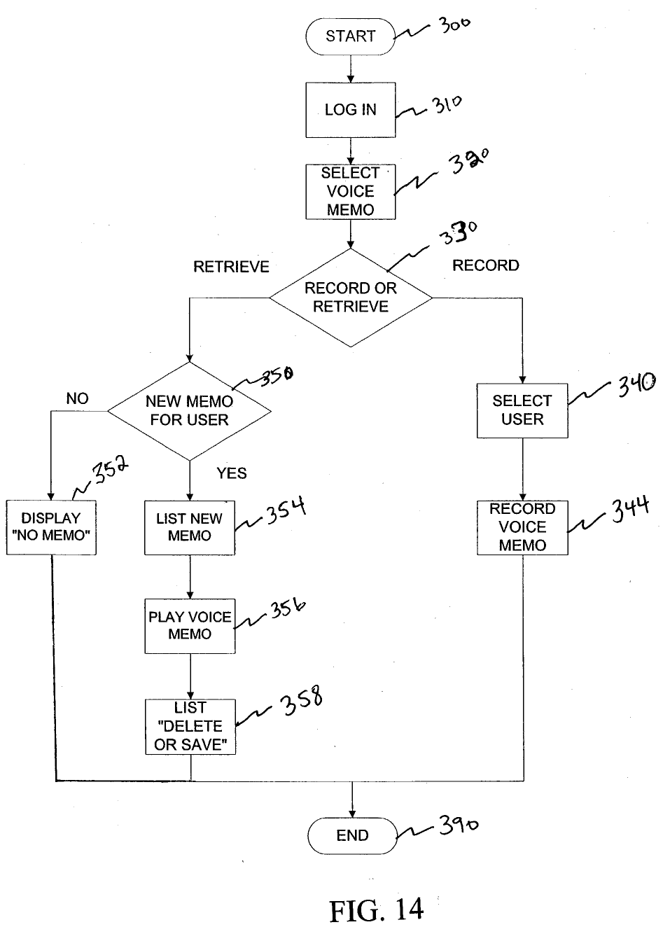

FIG. 14 is a flow chart of a voice memo process of the organizer commencing with block 300. In one embodiment, the organizer 100 includes a voice memo system process. The organizer 100 may include a microphone and speaker system for recording and playing the voice memos. In one embodiment, the voice memo system process is accessed from the touch pad 118 by pressing a key 129 designated for the voice memo process. The voice memo process includes features that permit a user to record or retrieve a voice memo. In one embodiment, a user may record a voice memo for a specific user, such that only an intended user may access and play the voice memo. In other embodiments, a user may record a voice memo that may be accessed by any user. In one embodiment, multiple messages may be stored for any user. As noted in FIG. 14, a user typically logs in at block 310 by entering a user ID and/or password. At block 320, the user selects voice memo from a main menu, and the organizer 100 prompts the user to select whether to record or retrieve new or old (previously played) memos, as illustrated in block 330. If the user desires to record a new memo, the user selects one or more users (which may be private or public) at block 340. At block 344 the user records the memo by indicating to the organizer 100 the start and end of the recording memo. On the other hand if the user decides to retrieve recorded memos, the organizer determines whether there are any recorded memos, as illustrated in block 350. If there are no memos for this user, the organizer 100 displays to the user “No Memo”, or a similar phrase, as illustrated in block 352. On the other hand, the organizer 100 displays a list of the new memos if there are new voice memos for the user, as illustrated in block 354. At block 356, the organizer 100 prompts the user to play the voice memo(s). After playing the voice memo, the user may delete or save or forward to other user(s) the voice memo, as illustrated in block 358. This process terminates in block 390.

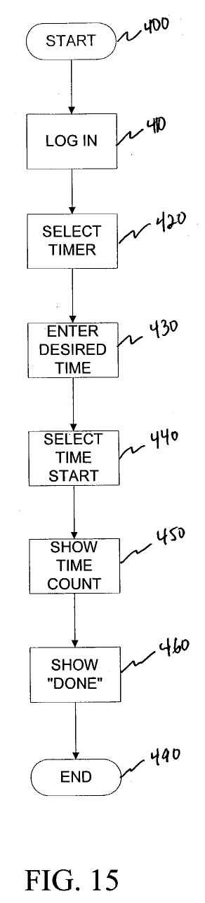

FIG. 15 is a flow chart of the timer process of the organizer commencing in block 400. The kitchen timer process may be accessed from the touch pad 118 by pressing a key 130 designated for the kitchen timer process. As described previously in connection with the above processes, the user may log in at block 410. At block 420, the user selects the timer function from the main menu. At block 430, the user may then enter a desired time and start the timer, as illustrated in block 440. In one embodiment, the timer will count down to zero and show the count to the user, as illustrated in block 450. In block 460, the organizer 100 may indicate to the user by an audible sound and/or visually completion of the count, such as by indicating “DONE” when the timer reaches zero. This is a very convenient function for the user who may be placing the organizer 100 in the kitchen area of the home, such as by attaching the organizer 100 to an appliance, such as a refrigerator. In such a location, the user can use the organizer, not only to manage and store/retrieve information, but to time events in the kitchen such as cooking time. This process terminates at block 490.

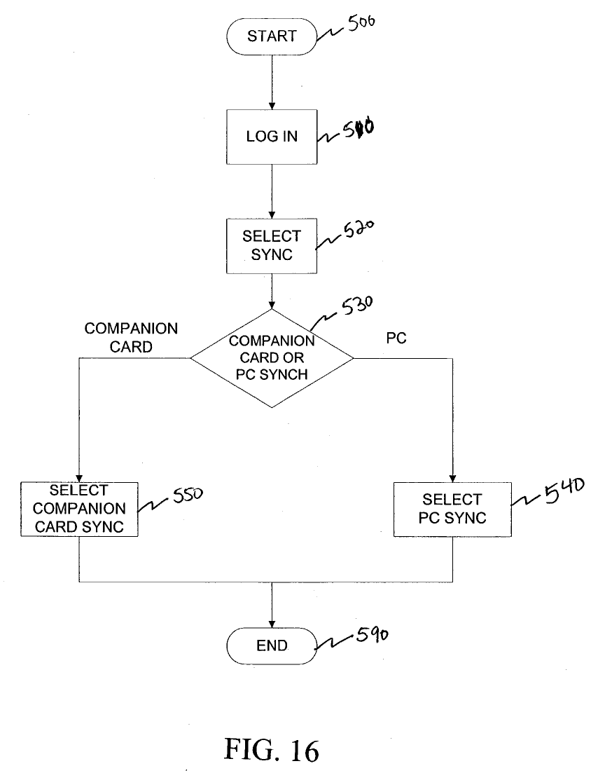

FIG. 16 is a flow chart of the companion card 150 synchronization process of the organizer 100 commencing in block 500. In one embodiment, a user logs in and selects the synchronization process from the display of the organizer 100, as illustrated in blocks 510 and 520. In one embodiment, a user may select to synchronize from the companion card 150. Alternatively, the user activates the synchronization process by simply inserting or connecting the companion card into/to the organizer 100. This latter activation method (i.e. automatic) may be activated by the detection of the companion card 150 by the organizer 100 upon insertion. For example, the companion card may be configured to promptly communicate an activation signal to the organizer 100 upon insertion indicating that the companion card 150 is present and requesting access to the organizer 100. In another example, the organizer 100 may include an activation button inside or in the vicinity of the receiving slot 140, which when pressed by the body of the companion card 150, initiates synchronization. In other embodiments, the synchronization process is user-defined. In embodiments where the synchronization process is automatic, the card reader is adapted to identify the user by the card and automatically synchronize data. In one embodiment, the organizer 100 may require a password, which permits a user to begin data transfer.

Typically, the synchronization process transmits data related to the schedule, or any other desired function of the organizer, including telephone records, to-do lists and shopping lists. The synchronization process permits users to transfer data to and from the companion card 150 or a PC to and from the organizer 100, as determined in block 530. If the synchronization of the organizer 100 is with a PC, the process proceeds to block 540. In that case, a PC may be connected to the organizer using a cable connector, such as a USB or serial connector. If the synchronization of the organizer 100 is with the companion card 550, the process proceeds to block 550. This process terminates at block 590.

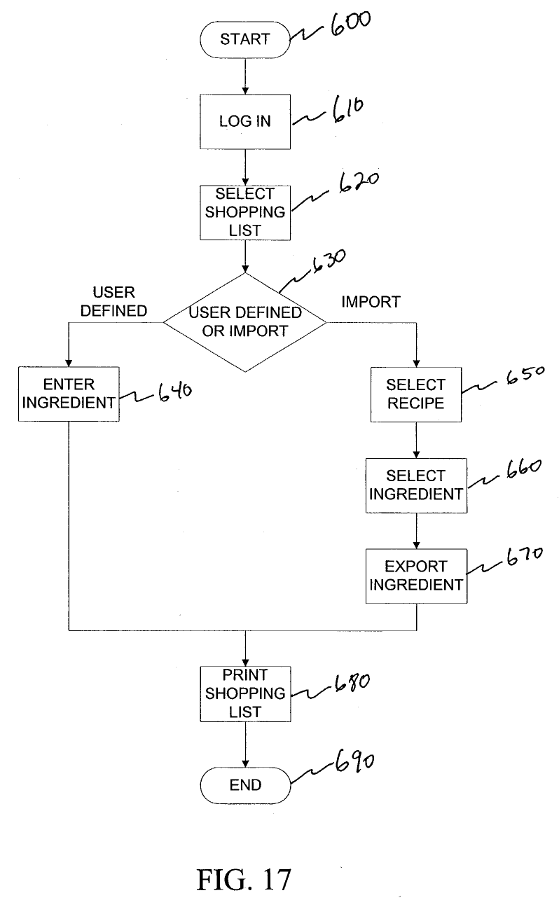

FIG. 17 is a flow chart of the recipe exporting process of the organizer commencing in block 600. The kitchen recipe process permits users to access recipes and selectively export ingredients to a shopping list, which may be printed or transferred to the companion card 150 or other device automatically. As indicated in connection with the processes above, the user may log in and select the desired function, i.e., “shopping list” from the main menu, as illustrated in blocks 610 and 620. With the kitchen recipe process, a user may create (i.e., define) a new recipe or access an existing recipe, as illustrated in decision block 630. If the user desires to enter a new recipe, the process proceeds to block 640 where the user is prompted to enter ingredients or description. On the other hand, if the user desires to import or export a recipe, the user can select the “recipe” from the organizer 100 for exporting to an external device, e.g., companion card 150, as illustrated in block 650. In one embodiment, a user may export an entire recipe or user-defined ingredients from the recipe to the shopping list or a user may input items into the shopping list individually, as illustrated in block 660. A user may also delete the shopping list entirely or particular ingredients from the shopping list. Finally, the user may simply export the entire or part of the ingredients to the companion card 150, as illustrated in block 670. In one embodiment, the user may also print the shopping list, as illustrated in block 680. This process terminates at block 690.

As used herein, the term “recipe” is not limited to food or meal recipes but may refer to any list that includes one or more items for making a final product. In one embodiment, the recipes may be organized into recipes for an appetizer, main course, soup or salad, or a dessert. A user may search the recipes, display all recipes, or input recipes. In one embodiment, a user may print out a desired recipe.

In one embodiment, the organizer 100 may include features for internet access, automatic phone dialing, wireless intercom and network, video conferencing, music downloading, picture sharing, security observation systems, and games. For example, a record stored within the phone directory of the organizer 100 may be accessed and a command given to the organizer 100 to dial the number shown. The organizer, through connections to a telephone using standard input/output jacks, activates the phone dial tone and standard phone dialing systems, such as dual tone multi-frequency (DTMF) tones. In another embodiment, the organizer 100 may be enabled to connect to the internet via a computer network using wired or wireless network technology or connect directly to the internet using its own dial-up connection or network connection and embedded browser software.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. An organizer for managing and storing information, the organizer comprising:
a housing having first and second portions connected at an angle between the first and second portions, the angle being selected to allow placement of the body on a substantially horizontal or substantially vertical surface;
an input portion located substantially on an upper surface of the first portion and configured to allow a user to enter instructions or information into the organizer, wherein a bottom surface of the first portion is configured to be placed substantially in contact with the horizontal surface; and
a display portion located substantially on an upper surface of the second portion and configured to display information to the user, wherein a bottom surface of the second portion is configured to be placed substantially in contact with the vertical surface.

2. The organizer of claim 1, further comprising a connector located in the first portion for connecting a printer to the first portion of the housing.

3. The organizer of claim 1, further comprising a connector located in the second portion for connecting a printer to the second portion of the housing.

4. The organizer of claim 1, further comprising mechanical connectors for attaching the second portion of the housing to the vertical surface and, alternatively, connecting a printer to the second portion.

5. The organizer of claim 1, further comprising mechanical connectors for attaching the first portion of the housing to a printer.

6. The organizer of claim 1, further comprising at least one outlet for connector the organizer to a plain old telephone (POT) line or to a communication network.

7. The organizer of claim 1, further comprising first and second electrical connectors, the first electrical connector being located in the first portion of the housing for connecting a printer to the first portion, and the second connector being located in the second portion of the housing for connecting the printer to the second portion, thereby allowing reversible placement of the printer relative to the organizer.

8. The organizer of claim 1, further comprising a receiving connector configured to receive and connect to an external card for exchanging information between the organizer and the external card.

9. The organizer of claim 8, wherein the organizer is configured to export one or more ingredient of a recipe from the organizer to the external card.

10. The organizer of claim 8, wherein the organizer is configured to start and end a timer for measuring passing time.

11. The organizer of claim 8, wherein the organizer is configured to communicate to the external card information including at least one of schedule, telephone list, voice memo, written memo, shopping list, and recipe information.

12. The organizer of claim 1, further comprising a speaker and a microphone for allowing a user to listen and record messages from and to at least one other user of the organizer.

13. The organizer of claim 1, further comprising a menu comprising a list of functions accessible by multiple authorized users.

14. The organizer of claim 1, wherein the organizer is configured to allow a master user to access data of multiple individual users, and wherein the data of said individual users appends to data stored by the master user.

15. A method of managing and storing information in an organizer, the method comprising:
inputting data into the organizer by a plurality of individual users, the data representing information about at least one activity associated with a respective individual user;
copying the data inputted by the plurality of individual user into a master data file in the organizer, the master data file being accessible by a master user via the organizer; and
verifying at least the authority of the master user to access the master data file containing the copied data.

16. The method of claim 15, further comprising displaying at least a selected portion of the copied data to the master user.

17. The method of claim 15, wherein inputting data includes entering at least one of a note, a voice memo, a scheduling entry, a to-do list, a phone number, an email, a recipe entry, a shopping list item, a scheduled alarm, a calendar entry, and synchronized data.

18. The method of claim 15, wherein the organizer is configured to be portable and conveniently placed in a palm of a human hand.

19. The method of claim 15, wherein the organizer comprises:
a housing having first and second portions connected at an angle between the first and second portions, the angle being selected to allow placement of the body on a substantially horizontal or substantially vertical surface;
an input portion located substantially on an upper surface of the first portion and configured to allow a user to enter instructions or information into the organizer, wherein a bottom surface of the first portion is configured to be placed substantially in contact with the horizontal surface; and
a display portion located substantially on an upper surface of the second portion and configured to display information to the user, wherein a bottom surface of the second portion is configured to be placed substantially in contact with the vertical surface.

20. An organizer for managing and storing information, the organizer comprising:
means for inputting data into the organizer by a plurality of individual users, the data representing information about at least one activity associated with a respective individual user;
means for copying the data inputted by the plurality of individual users into a master data file in the organizer, the master data file being accessible by a master user via the organizer; and
means for verifying at least the authority of the master user to access the master data file containing the data inputted by the plurality of individual users.
